(19) United States
(12) Patent Application Publication
(10) Pub. No.: US 2018/0340598 A1
(43) Pub. Date: Nov. 29, 2018

(54) PROTECTIVE COVER AND GEAR ASSEMBLY

(71) Applicant: SIKORSKY AIRCRAFT CORPORATION, Stratford, CT (US)

(72) Inventors: John William BEISNER, Madison, CT (US); Timothy FORREST, Madison, CT (US)

(21) Appl. No.: 15/771,645

(22) PCT Filed: Oct. 19, 2016
(86) PCT No.: PCT/US2016/057678

§ 371 Date: Apr. 27, 2018

Related U.S. Application Data
(60) Provisional application No. 62/247,602, filed on Oct. 28, 2015.

(51) Int. Cl. F16H 37/00

(52) U.S. Cl. CPC F16H 37/00

(57) ABSTRACT

A protective cover is disclosed for teeth of a gear body. The protective cover includes a desiccant disposed in a polymer enclosure. A method of protecting a gear is disclosed. The method involves generating a digital model of a protective cover having a surface portion that matches a surface contour of the gear teeth and inputting the digital model into an additive manufacturing apparatus or system. A protective cover is formed by repeatedly applying energy from an energy source to fuse successively applied incremental quantities of a polymer corresponding to the digital model of the protective cover, and the gear teeth are covered with the surface portion of the protective cover that matches the surface contour of the gear teeth.

### BACKGROUND

A gear is a rotating machine used to transmit torque. Typically, teeth on the gear (also sometimes referred to as cogs) mesh with another toothed component to transfer torque to or from the gear. Gears can be used in combination with other gears of varying sizes to transfer torque while providing a mechanical advantage by changing the speed, torque, or even the direction of movement. They can also be used in combination with a non-rotating toothed part such as in a rack and pinion mechanism to translate between linear and rotational motion. Gears have been used in a wide variety of applications from mechanical timepieces to power transmissions for vehicles or other powered machines. A degree of dimensional precision is required for the gear teeth to mesh properly with other toothed components. Additionally, the tooth surface characteristics need to be controlled to provide smooth and reliable interaction with other toothed components.

A number of factors can adversely impact the gear teeth, which can lead to improper gear meshing, shorter gear life, or even catastrophic gear failure. For example, during fabrication, some period of time often must pass between the time when the toothed gear body is formed and the time when the gear teeth are subjected to fine machining to obtain the desired dimensional precision or the time when the gear body is subjected to final inspection. During this time, the gear typically sits exposed where it is subjected to a number of risks. Exposure during this time to atmospheric oxygen, heat, moisture, other airborne contaminants, or combinations thereof can lead to oxidation, corrosion, or surface contamination, which can cause pitting or other surface degradation of the gear teeth surfaces. Contact with machinery or anything in the surrounding environment can also cause nicks on the surface or physical deformation of gear teeth. Also, the unprotected gear body is subject to foreign object debris (“FOD”) falling into the spaces in the gear teeth, which can also damage the gear teeth or adversely impact performance of the gear mechanism if not removed with an extra cleaning process before final assembly into a gear mechanism. Even handling by personnel can contaminate gear teeth surfaces with human skin oils or other foreign matter from the hands of the personnel. These risks are also still present after final machining or inspection of the gear up until it is installed into a gear mechanism, for example with spare parts. Some of these post-fabrication risks can be mitigated with conventional packaging, but conventional packaging cannot eliminate all risks (e.g., exposure to atmospheric oxygen).

### BRIEF DESCRIPTION

In some aspects a protective cover for gear teeth of a gear body is disclosed, comprising a desiccant disposed in a polymer enclosure.

In some aspects, a method is disclosed of protecting a gear body comprising a plurality of gear teeth. The method comprises generating a digital model of a protective cover having a surface portion that matches a surface contour of the gear teeth and inputting the digital model into an additive manufacturing apparatus or system comprising an energy source. A protective cover is formed by repeatedly applying energy from the energy source to fuse successively applied incremental quantities of a polymer corresponding to the digital model of the protective cover. The gear teeth are covered with the surface portion of the protective cover that matches the surface contour of the gear teeth. In some aspects of the method, a desiccant is also enclosed within the protective cover.

In some aspects, the gear teeth surfaces define a negative space surrounding the gear teeth, and this negative space is occupied by the protective cover or polymer enclosure.

In some aspects, the protective cover or polymer enclosure comprises a polymer shell, and the desiccant is disposed within the polymer shell.

In some aspects, a polymer support structure is disposed within the polymer shell.

In some aspects, the polymer support structure comprises a honeycomb structure, a columnar structure, or a diagonal structure.

In some aspects, the polymer shell comprises a porous portion covering the gear teeth.

In some aspects, the polymer shell porous portion comprises polymer strands or strips configured in a pattern with openings between the strands or strips.

In some aspects, the desiccant comprises desiccant particles larger than openings in the polymer shell porous portion.

In some aspects, the polymer enclosure comprises a polymer foam, and the desiccant is disposed within cells in the polymer foam.

In some aspects, the polymer foam is an open-cell polymer foam.

In some aspects, a gear assembly is disclosed comprising a gear body comprising gear teeth, and a removable protective cover according to any of the aspects described herein covering the gear teeth.

### BRIEF DESCRIPTION OF THE DRAWINGS

Subject matter of this disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic depiction of a cross-section view of a gear assembly;

FIG. 2 is a schematic depiction of a perspective view of a protective cover;

FIG. 3 is a schematic depiction of a cross-section view of a portion of a gear assembly;

FIG. 4 is a schematic depiction of a cross-section view of a portion of a gear assembly;

FIG. 5 is a schematic depiction of a top view of a portion of a protective cover; and

FIGS. 6A and 6B provide a schematic depiction of a porous shell for a protective cover.

### DETAILED DESCRIPTION

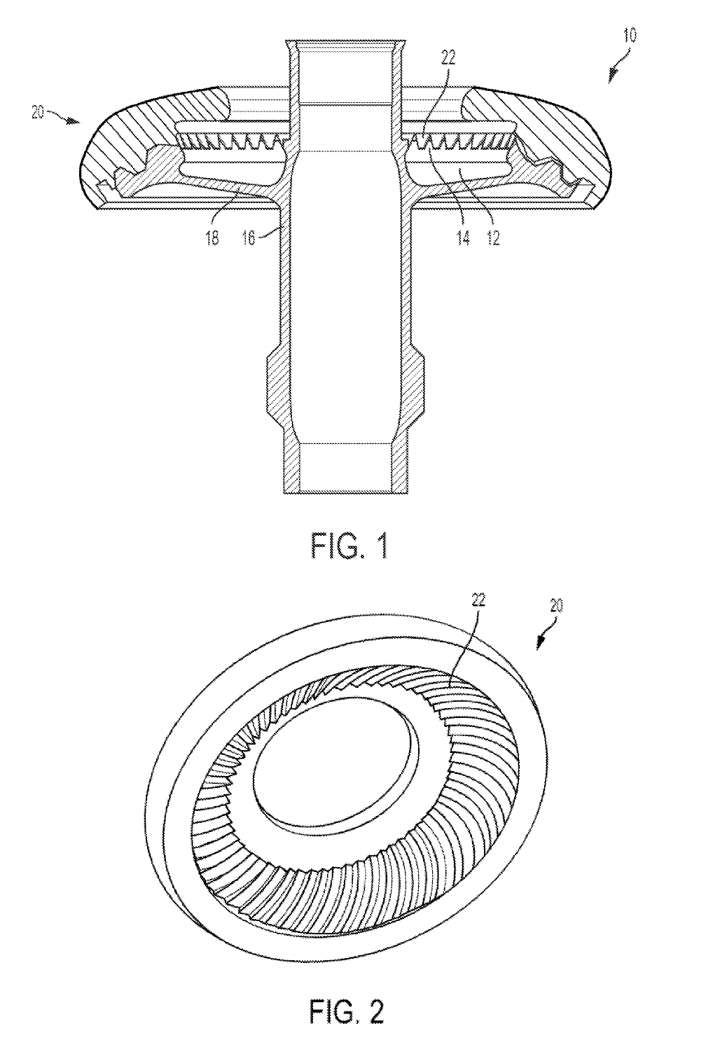

Turning now to the Figures, a gear assembly 10 is depicted in a cross-section view FIG. 1. As shown in FIG. 1, a gear body 12 is shown having gear teeth 14. The gear body 12 is connected to a rotor 16, which can in turn be connected to a rotating component in a mechanical device or machine. In the embodiment as illustrated in FIG. 1, the rotor 16 includes an integrated gear support 18. As further shown in FIG. 1, a protective cover 20 covers the gear teeth. Protective cover 20 is further illustrated in perspective view in FIG. 2. As shown in FIGS. 1 and 2, protective cover 20 includes teeth 22 that have a contour matching that of gear teeth 14. When the protective cover 20 is in place covering the gear teeth 14 as shown in FIG. 1, the protective cover teeth 22 occupy a negative space defined by the surfaces of the gear teeth 14. This negative space is defined as the space adjacent to the surfaces of gear teeth 14 that would be empty but for the presence of protective cover teeth 22 shown in FIG. 1 or an adjacent meshed gear (not shown) in a gear mechanism.

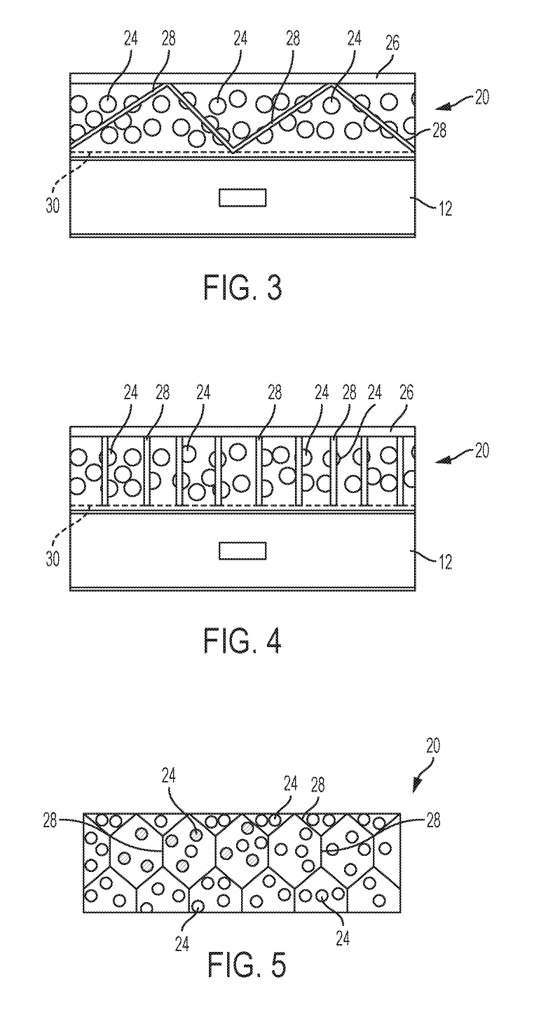

As mentioned above, the protective cover 20 can comprise a desiccant disposed in a polymer enclosure, as illustrated in FIGS. 3-5. FIGS. 3-5 illustrate embodiments where desiccant particles 24 are disposed within a polymer shell 26. FIGS. 3 and 4 depict side-view cross-sections of a portion of protective cover 20 over a gear body 12 (for ease of illustration, the gear teeth 14 and protective cover teeth 22 are not shown in FIGS. 3-4) where desiccant particles 24 are disposed in hollow space within a polymer shell 26. FIG. 5 depicts a top-view of a portion of protective cover 20 viewed through a transparent polymer shell 26 (not labeled). The space within the polymer shell can also include a polymer support structure 28. The support structure 28 can have various configurations, including but not limited to diagonal support structures as shown in FIG. 3, columnar support structures as shown in FIG. 4, or honeycomb support structures as shown in FIG. 5.

The desiccant can be selected from any of a number of known desiccant materials. Examples of desiccant materials include, but are not limited to silica, calcium sulfate, calcium chloride, zeolites, or activated carbon. The desiccant can be in various forms such as particles as shown in FIGS. 3-5, or can be in the form of a porous monolith. In some embodiments, the desiccant can include a moisture level indicator such as a color change indicator (which can be viewed through a transparent portion of the polymer shell) to indicate relative saturation of the desiccant with moisture so that it can be regenerated by drying such as by exposure to heat. Examples of moisture level indicators include cobalt chloride, which changes from blue to purple to pink with increasing levels of moisture. Other moisture level indicators can be utilized as well, such as a micro-strain indicator incorporated into the polymer shell that is responsive to stress imposed by volumetric expansion of the desiccant caused by absorption of moisture.

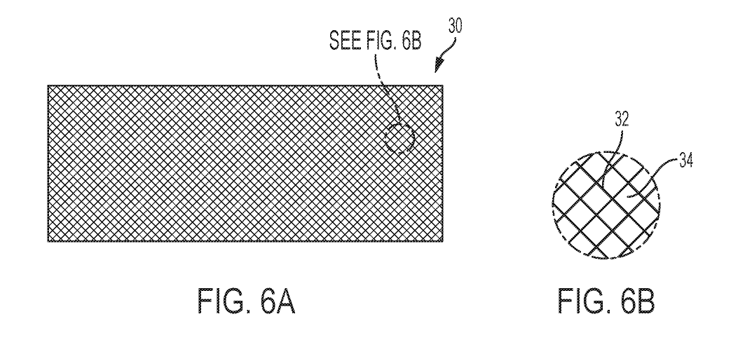

In some aspects, the portion of the polymer shell adjacent to the gear body 12 can be a porous membrane or shell 30 to facilitate removal of moisture from the area around the surface of the gear body 12. Any of a number of known porous membranes or materials can be used as porous membrane or shell 30. An example of an embodiment of a porous membrane is depicted in FIG. 6, where polymer strands or strips 32 are configured in a pattern with openings between the strands or strips 32. In the case where the desiccant is in the form of desiccant particles, the openings 34 between the strands or strips 32 can be smaller than the size of the desiccant particles to retain the desiccant particles within the polymer shell while allowing moisture to transfer across the porous membrane or shell 30. Other porous membranes can be utilized as well, including but not limited to woven or non-woven fiber layers or semi-permeable polymer membranes.

In some aspects, the protective cover can include identification that can be used for process tracking, such as tracking the location of the gear assembly or its progress through manufacturing. Examples of known identification techniques include embedding of solid state electronic identification chips (e.g., RFID) or placement of visual identification (e.g., bar code or a simple identification number) on a visible exterior surface of the protective cover. Since the protective cover can be re-used on other gear bodies after the gear body being processed exits the manufacturing process, this can improve efficiency by avoiding the necessity of applying tracking identification to each part being manufactured. Of course, the protective cover can be re-used (optionally with cleaning of the protective cover and/or regeneration of the desiccant) regardless of whether it includes identification.

As mentioned above, in some aspects of this disclosure, additive manufacturing is used to fabricate a protective cover for a gear, the protective cover having a surface portion that matches a surface contour of the gear teeth. In some embodiments, a method comprises generating a digital model of a protective cover having a surface portion that matches a surface contour of the gear teeth and inputting the digital model into an additive manufacturing apparatus or system comprising an energy source. A protective cover is formed by repeatedly applying energy from the energy source to fuse successively applied incremental quantities of a polymer corresponding to the digital model of the protective cover. The gear teeth are covered with the surface portion of the protective cover that matches the surface contour of the gear teeth. In some aspects of the method, a desiccant is also enclosed within the protective cover. Additive manufacturing techniques can used to produce a wide variety of structures that are not readily producible by conventional manufacturing techniques such as injection molding (e.g., internal support structures, certain gear tooth profiles, porous shell having openings between polymer strands or strips). When a desiccant is incorporated into a protective cover manufactured by additive manufacturing techniques, it can be incorporated during the fabrication process, such as by removing unfused powder with an air knife and replacing it with desiccant particles after each layer is fused in a powder bed additive manufacturing process. Alternatively, desiccant particles can be introduced after completion of the manufacturing process, such as by fabricating a structure such as shown in FIG. 4 or 5 except for a portion of the shell 26, introducing desiccant after into the spaces between the columnar or honeycomb support structures 28, and then fabricating the remaining portion of the shell 26 with conventional fabrication techniques such as molding or with an additional additive manufacturing process step.

The digital models used in the practice of the invention are well-known in the art, and do not require further detailed description here. The digital model can be generated from various types of computer aided design (CAD) software, and various formats are known, including but not limited to SLT (standard tessellation language) files, AMF (additive manufacturing format) files, PLY files, wavefront (.obj) files, and others that can be open source or proprietary file formats.

Various types of additive manufacturing materials, energy sources, and processes can be used to fabricate the protective cover and the individual features thereof that are described herein. The types of polymers used in such process are well-known in the art and do not require further detailed explanation herein. Examples of polymers include polyurethanes, polystyrenes, polyesters, polyolefins, acrylic polymers, among others. In some aspects, the polymer has sufficient elasticity to provide flexibility to the protective cover to facilitate easy installation onto and removal from the gear body. The type of additive manufacturing process used depends in part on the type of material out of which it is desired to manufacture the protective cover. Processes for polymer additive manufacturing can include stereolithography (SLA), in which fabrication occurs with the workpiece disposed in a liquid photopolymerizable composition, with a surface of the workpiece slightly below the surface of the liquid composition. Light from a laser or other light beam is used to selectively photopolymerize a layer onto the workpiece, following which it is lowered further into the liquid composition by an amount corresponding to a layer thickness and the next layer is formed. Polymer structures can also be fabricated using selective heat sintering (SHS), which works analogously for thermoplastic powders to selective laser sintering for metal powders. Another exemplary additive manufacturing process that can be used for polymers is fused deposition modeling (FDM), in which a thermoplastic feed material (e.g., in the form of a wire or filament) is heated and selectively dispensed onto the workpiece through an extrusion nozzle.

The protective cover can also be formed from conventional manufacturing techniques such as injection molding or reactive injection molding. For example, a desiccant can be incorporated into a polymer foam-forming composition such as a polyurethane foam, polystyrene foam, polyolefin, or other polymer foam systems. A blowing agent such as a volatile hydrocarbon or a blowing agent formed in situ (e.g., CO₂ formed by incorporation of water in a polyurethane reaction mixture) can be used to provide a cell structure for a foamed polymer. In some aspects, an open-cell polymer foam is used to facilitate transport of moisture to and from the desiccant, optionally combined with a more rigid skin or shell to provide structural integrity.

This disclosure further encompasses the following embodiments, which are non-limiting.

Embodiment 1: A protective cover for a gear body comprising gear teeth, comprising a desiccant disposed in a polymer enclosure.

Embodiment 2: The protective cover of embodiment 1, wherein the gear teeth surfaces define a negative space surrounding the gear teeth, said negative space occupied by the polymer enclosure.

Embodiment 3: The protective cover of embodiments 1 or 2, wherein the polymer enclosure comprises a polymer shell, and the desiccant is disposed within the polymer shell.

Embodiment 4: The protective cover of embodiment 3, wherein the polymer enclosure further comprises a polymer support structure within the polymer shell.

Embodiment 5: The protective cover of embodiment 4, wherein the polymer support structure comprises a honeycomb structure, a columnar structure, or a diagonal structure.

Embodiment 6: The protective cover of embodiment 3, wherein the polymer shell comprises a porous portion covering the gear teeth.

Embodiment 7: The protective cover of embodiment 6, wherein the polymer shell porous portion comprises polymer strands or strips configured in a pattern with openings between the strands or strips.

Embodiment 8: The protective cover of embodiment 7, wherein the desiccant comprises desiccant particles larger than said openings.

Embodiment 9: The protective cover of embodiments 1 or 2, wherein the polymer enclosure comprises a polymer foam, and the desiccant is disposed within cells in the polymer foam.

Embodiment 10: The protective cover of embodiment 9, wherein the polymer foam is an open-cell polymer foam.

Embodiment 11: The protective cover of any of embodiments 1-10, further comprising an indicator of moisture retention by the desiccant.

Embodiment 12: The protective cover of any of embodiments 1-11, further comprising identification for process tracking.

Embodiment 13: A gear assembly, comprising a gear body comprising gear teeth; and a removable protective cover according to any of embodiments 1-12 covering the gear teeth.

Embodiment 14: A method of protecting a gear body comprising gear teeth, the method comprising: generating a digital model of a protective cover having a surface portion that matches a surface contour of the gear teeth; inputting the digital model into an additive manufacturing apparatus or system comprising an energy source; forming the protective cover by repeatedly applying energy from the energy source to fuse successively applied incremental quantities of a polymer corresponding to the digital model of the protective cover; and covering the gear teeth with the surface portion of the protective cover that matches the surface contour of the gear teeth.

Embodiment 15: The method of embodiment 14, further comprising enclosing a desiccant within the protective cover.

Embodiment 16: The method of embodiment 15, wherein the digital model includes an exterior shell, and the desiccant is disposed within the exterior shell.

Embodiment 17: The method of embodiment 16, wherein the digital model includes a support structure within the exterior shell.

Embodiment 18: The method of embodiment 17, wherein the support structure comprises a honeycomb structure, a columnar structure, or a diagonal structure.

Embodiment 19: The method of any of embodiments 14-18, wherein the digital model includes a porous portion matching the surface contour of the gear teeth.

Embodiment 20: The method of embodiment 19, wherein the digital model of the porous portion includes strands or strips configured in a pattern with openings between the strands or strips.

Embodiment 21: The method of embodiment 20 based on embodiment 19 as it depends from any of embodiments 16-18, wherein the desiccant comprises desiccant particles larger than said openings.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A protective cover for a gear body comprising gear teeth, comprising a desiccant disposed in a polymer enclosure.

2. The protective cover of claim 1, wherein the gear teeth surfaces define a negative space surrounding the gear teeth, said negative space occupied by the polymer enclosure.

3. The protective cover of claim 1, wherein the polymer enclosure comprises a polymer shell, and the desiccant is disposed within the polymer shell.

4. The protective cover of claim 3, wherein the polymer enclosure further comprises a polymer support structure within the polymer shell.

5. The protective cover of claim 4, wherein the polymer support structure comprises a honeycomb structure, a columnar structure, or a diagonal structure.

6. The protective cover of claim 3, wherein the polymer shell comprises a porous portion covering the gear teeth.

7. The protective cover of claim 6, wherein the polymer shell porous portion comprises polymer strands or strips configured in a pattern with openings between the strands or strips.

8. The protective cover of claim 7, wherein the desiccant comprises desiccant particles larger than said openings.

9. The protective cover of claim 1, wherein the polymer enclosure comprises a polymer foam, and the desiccant is disposed within cells in the polymer foam.

10. The protective cover of claim 9, wherein the polymer foam is an open-cell polymer foam.

11. The protective cover of claim 1, further comprising an indicator of moisture retention by the desiccant.

12. The protective cover of claim 1, further comprising identification for process tracking.

13. A gear assembly, comprising
a gear body comprising gear teeth; and
a removable protective cover according to claim 1 covering the gear teeth.

14. A method of protecting a gear body comprising gear teeth, the method comprising:
generating a digital model of a protective cover having a surface portion that matches a surface contour of the gear teeth;
inputting the digital model into an additive manufacturing apparatus or system comprising an energy source;
forming the protective cover by repeatedly applying energy from the energy source to fuse successively applied incremental quantities of a polymer corresponding to the digital model of the protective cover; and
covering the gear teeth with the surface portion of the protective cover that matches the surface contour of the gear teeth.

15. The method of claim 14, further comprising enclosing a desiccant within the protective cover.

16. The method of claim 15, wherein the digital model includes an exterior shell, and the desiccant is disposed within the exterior shell.

17. The method of claim 16, wherein the digital model includes a support structure within the exterior shell.

18. The method of claim 17, wherein the support structure comprises a honeycomb structure, a columnar structure, or a diagonal structure.

19. The method of claim 14, wherein the digital model includes a porous portion matching the surface contour of the gear teeth.

20. The method of claim 19, wherein the digital model of the porous portion includes strands or strips configured in a pattern with openings between the strands or strips.

21. (canceled)
